(19) United States
(12) Patent Application Publication
(10) Pub. No.: US 2014/0098692 A1
(43) Pub. Date: Apr. 10, 2014

(54) SCHEDULING INTER-RADIO ACCESS TECHNOLOGY (IRAT) MEASUREMENT DURING CONTINUOUS DATA TRANSMISSION

(71) Applicant: QUALCOMM Incorporated, San Diego, CA (US)

(72) Inventors: Insung KANG, San Diego, CA (US); Surendra BOPPANA, San Diego, CA (US); Qingxin CHEN, Del Mar, CA (US); Hari SANKAR, San Diego, CA (US)

(73) Assignee: QUALCOMM Incorporated, San Diego, CA (US)

(21) Appl. No.: 14/049,762

(22) Filed: Oct. 9, 2013

Related U.S. Application Data
(60) Provisional application No. 61/712,098, filed on Oct. 10, 2012.

(51) Int. Cl. H04W 24/10

(52) U.S. Cl. CPC H04W 24/10
USPC 370/252

(57) ABSTRACT

A user equipment (UE) may improve scheduling of inter radio access technology (IRAT) measurement during continuous data transmission, for example in a High Speed-Physical Downlink Shared Channel (HS-PDSCH). The UE may determine whether an IRAT measurement is desired. The UE may also perform the IRAT measurement during a scheduled downlink data subframe when it is determined the IRAT measurement is desired, without losing the scheduled downlink data.

### CROSS-REFERENCE TO RELATED APPLICATION

This application claims the benefit under 35 U.S.C. §119(e) to U.S. Provisional Patent Application No. 61/712,098 entitled SCHEDULING IRAT MEASUREMENT DURING CONTINUOUS DATA TRANSMISSION, filed on Oct. 10, 2012, in the names of KANG, et al., the disclosure of which is expressly incorporated by reference herein in its entirety.

### BACKGROUND

1. Field

Aspects of the present disclosure relate generally to wireless communication systems, and more particularly, to scheduling inter radio access technology (IRAT) and other measurements during continuous data transmission.

2. Background

Wireless communication networks are widely deployed to provide various communication services such as telephony, video, data, messaging, broadcasts, and so on. Such networks, which are usually multiple access networks, support communications for multiple users by sharing the available network resources. One example of such a network is the Universal Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). The UMTS, which is the successor to Global System for Mobile Communications (GSM) technologies, currently supports various air interface standards, such as Wideband-Code Division Multiple Access (W-CDMA), Time Division-Code Division Multiple Access (TD-CDMA), and Time Division-Synchronous Code Division Multiple Access (TD-SCDMA). For example, China is pursuing TD-SCDMA as the underlying air interface in the UTRAN architecture with its existing GSM infrastructure as the core network. The UMTS also supports enhanced 3G data communications protocols, such as High Speed Packet Access (HSPA), which provides higher data transfer speeds and capacity to associated UMTS networks. HSPA is a collection of two mobile telephony protocols, High Speed Downlink Packet Access (HSDPA) and High Speed Uplink Packet Access (HSUPA), that extends and improves the performance of existing wideband protocols.

As the demand for mobile broadband access continues to increase, research and development continue to advance the UMTS technologies not only to meet the growing demand for mobile broadband access, but to advance and enhance the user experience with mobile communications.

### SUMMARY

According to one aspect of the present disclosure, a method for wireless communication includes determining whether an inter radio access technology (IRAT) measurement is desired. The method may also include performing the IRAT measurement during a scheduled downlink data subframe when it is determined the IRAT measurement is desired, without losing scheduled downlink data.

According to another aspect of the present disclosure, an apparatus for wireless communication includes means for determining whether an inter radio access technology (IRAT) measurement is desired. The apparatus may also include means for performing the IRAT measurement during a scheduled downlink data subframe when it is determined the IRAT measurement is desired, without losing scheduled downlink data.

According to one aspect of the present disclosure, a computer program product for wireless communication in a wireless network includes a computer readable medium having non-transitory program code recorded thereon. The program code includes program code to determine whether an inter radio access technology (IRAT) measurement is desired. The program code also includes program code to perform the IRAT measurement during a scheduled downlink data subframe when the IRAT measurement is desired, without losing scheduled downlink data.

According to one aspect of the present disclosure, an apparatus for wireless communication includes a memory and a processor(s) coupled to the memory. The processor(s) is configured to determine whether an inter radio access technology (IRAT) measurement is desired. The processor(s) is further configured to perform the IRAT measurement during a scheduled downlink data subframe when the IRAT measurement is desired, without losing scheduled downlink data.

This has outlined, rather broadly, the features and technical advantages of the present disclosure in order that the detailed description that follows may be better understood. Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

FIG. 1 is a block diagram conceptually illustrating an example of a telecommunications system.

FIG. 2 is a block diagram conceptually illustrating an example of a frame structure in a telecommunications system.

FIG. 3 is a block diagram conceptually illustrating an example of a node B in communication with a UE in a telecommunications system.

FIG. 4 is a block diagram illustrating a method for scheduling IRAT measurement according to an aspect of the present disclosure.

FIG. 5 is a diagram illustrating an example of a hardware implementation for an apparatus employing a processing system according to one aspect of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

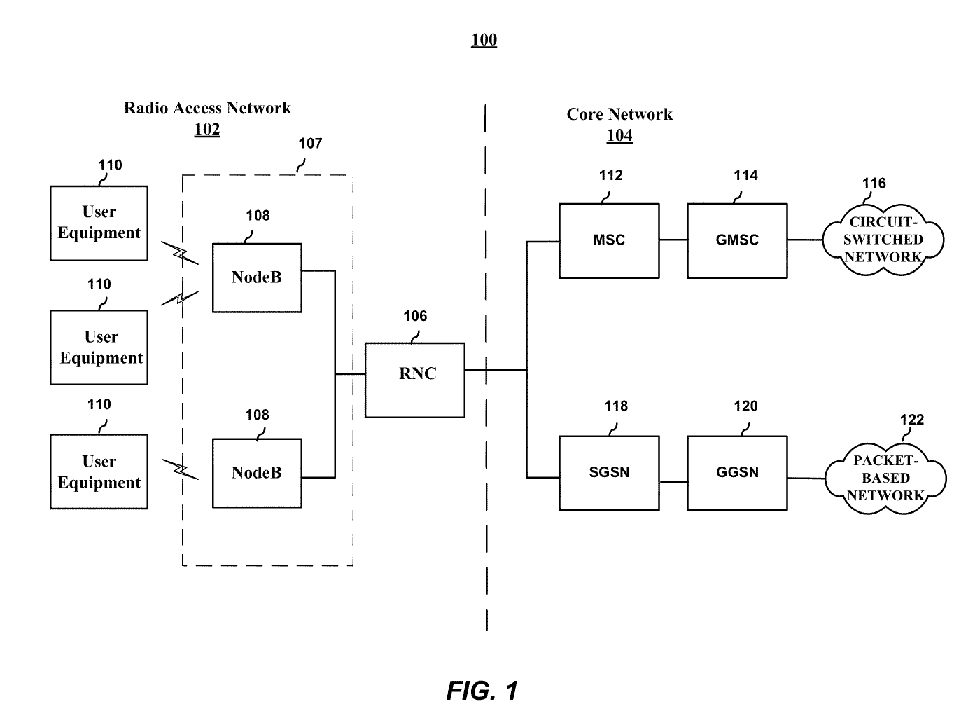

Turning now to FIG. 1, a block diagram is shown illustrating an example of a telecommunications system 100. The various concepts presented throughout this disclosure may be implemented across a broad variety of telecommunication systems, network architectures, and communication standards. By way of example and without limitation, the aspects of the present disclosure illustrated in FIG. 1 are presented with reference to a UMTS system employing a TD-SCDMA standard. In this example, the UMTS system includes a (radio access network) RAN 102 (e.g., UTRAN) that provides various wireless services including telephony, video, data, messaging, broadcasts, and/or other services. The RAN 102 may be divided into a number of Radio Network Subsystems (RNSs) such as an RNS 107, each controlled by a Radio Network Controller (RNC) such as an RNC 106. For clarity, only the RNC 106 and the RNS 107 are shown; however, the RAN 102 may include any number of RNCs and RNSs in addition to the RNC 106 and RNS 107. The RNC 106 is an apparatus responsible for, among other things, assigning, reconfiguring and releasing radio resources within the RNS 107. The RNC 106 may be interconnected to other RNCs (not shown) in the RAN 102 through various types of interfaces such as a direct physical connection, a virtual network, or the like, using any suitable transport network.

The geographic region covered by the RNS 107 may be divided into a number of cells, with a radio transceiver apparatus serving each cell. A radio transceiver apparatus is commonly referred to as a node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, two node Bs 108 are shown; however, the RNS 107 may include any number of wireless node Bs. The node Bs 108 provide wireless access points to a core network 104 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus is commonly referred to as user equipment (UE) in UMTS applications, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. For illustrative purposes, three UEs 110 are shown in communication with the node Bs 108. The downlink (DL), also called the forward link, refers to the communication link from a node B to a UE, and the uplink (UL), also called the reverse link, refers to the communication link from a UE to a node B.

The core network 104, as shown, includes a GSM core network. However, as those skilled in the art will recognize, the various concepts presented throughout this disclosure may be implemented in a RAN, or other suitable access network, to provide UEs with access to types of core networks other than GSM networks.

In this example, the core network 104 supports circuit-switched services with a mobile switching center (MSC) 112 and a gateway MSC (GMSC) 114. One or more RNCs, such as the RNC 106, may be connected to the MSC 112. The MSC 112 is an apparatus that controls call setup, call routing, and UE mobility functions. The MSC 112 also includes a visitor location register (VLR) (not shown) that contains subscriber-related information for the duration that a UE is in the coverage area of the MSC 112. The GMSC 114 provides a gateway through the MSC 112 for the UE to access a circuit-switched network 116. The GMSC 114 includes a home location register (HLR) (not shown) containing subscriber data, such as the data reflecting the details of the services to which a particular user has subscribed. The HLR is also associated with an authentication center (AuC) that contains subscriber-specific authentication data. When a call is received for a particular UE, the GMSC 114 queries the HLR to determine the UE's location and forwards the call to the particular MSC serving that location.

The core network 104 also supports packet-data services with a serving GPRS support node (SGSN) 118 and a gateway GPRS support node (GGSN) 120. GPRS, which stands for General Packet Radio Service, is designed to provide packet-data services at speeds higher than those available with standard GSM circuit-switched data services. The GGSN 120 provides a connection for the RAN 102 to a packet-based network 122. The packet-based network 122 may be the Internet, a private data network, or some other suitable packet-based network. The primary function of the GGSN 120 is to provide the UEs 110 with packet-based network connectivity. Data packets are transferred between the GGSN 120 and the UEs 110 through the SGSN 118, which performs primarily the same functions in the packet-based domain as the MSC 112 performs in the circuit-switched domain.

The UMTS air interface is a spread spectrum Direct-Sequence Code Division Multiple Access (DS-CDMA) system. The spread spectrum DS-CDMA spreads user data over a much wider bandwidth through multiplication by a sequence of pseudorandom bits called chips. The TD-SCDMA standard is based on such direct sequence spread spectrum technology and additionally calls for a time division duplexing (TDD), rather than a frequency division duplexing (FDD) as used in many FDD mode UMTS/W-CDMA systems. TDD uses the same carrier frequency for both the uplink (UL) and downlink (DL) between a node B 108 and a UE 110, but divides uplink and downlink transmissions into different time slots in the carrier.

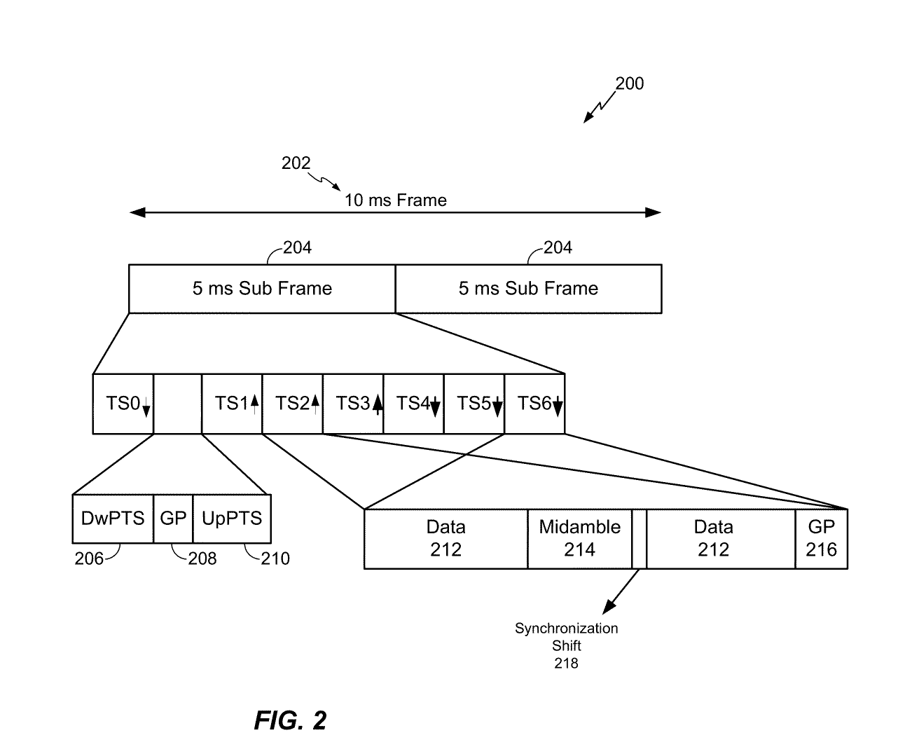

FIG. 2 shows a frame structure 200 for a TD-SCDMA carrier. The TD-SCDMA carrier, as illustrated, has a frame 202 that is 10 ms in length. The chip rate in TD-SCDMA is 1.28 Mcps. The frame 202 has two 5 ms subframes 204, and each of the subframes 204 includes seven time slots, TS0 through TS6. The first time slot, TS0, is usually allocated for downlink communication, while the second time slot, TS1, is usually allocated for uplink communication. The remaining time slots, TS2 through TS6, may be used for either uplink or downlink, which allows for greater flexibility during times of higher data transmission times in either the uplink or downlink directions. A downlink pilot time slot (DwPTS) 206, a guard period (GP) 208, and an uplink pilot time slot (UpPTS) 210 (also known as the uplink pilot channel (UpPCH)) are located between TS0 and TS1. Each time slot, TS0-TS6, may allow data transmission multiplexed on a maximum of 16 code channels. Data transmission on a code channel includes two data portions 212 (each with a length of 352 chips) separated by a midamble 214 (with a length of 144 chips) and followed by a guard period (GP) 216 (with a length of 16 chips). The midamble 214 may be used for features, such as channel estimation, while the guard period 216 may be used to avoid inter-burst interference. Also transmitted in the data portion is some Layer 1 control information, including Synchronization Shift (SS) bits 218. Synchronization Shift bits 218 only appear in the second part of the data portion. The Synchronization Shift bits 218 immediately following the midamble can indicate three cases: decrease shift, increase shift, or do nothing in the upload transmit timing. The positions of the SS bits 218 are not generally used during uplink communications.

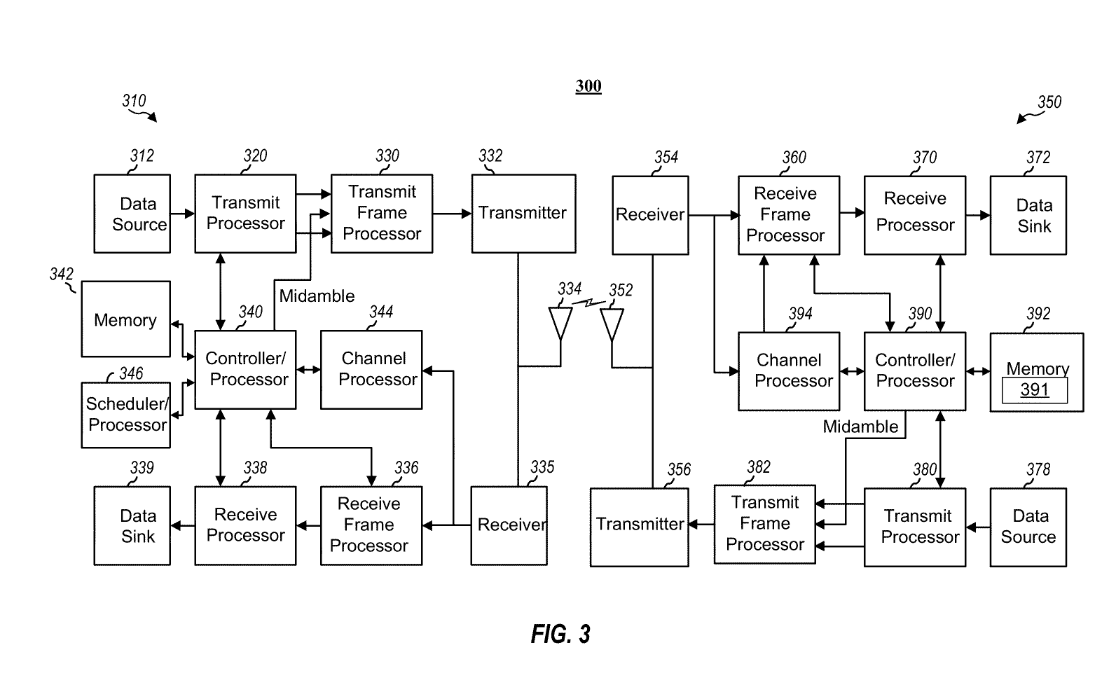

FIG. 3 is a block diagram of a node B 310 in communication with a UE 350 in a RAN 300, where the RAN 300 may be the RAN 102 in FIG. 1, the node B 310 may be the node B 108 in FIG. 1, and the UE 350 may be the UE 110 in FIG. 1. In the downlink communication, a transmit processor 320 may receive data from a data source 312 and control signals from a controller/processor 340. The transmit processor 320 provides various signal processing functions for the data and control signals, as well as reference signals (e.g., pilot signals). For example, the transmit processor 320 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 344 may be used by a controller/processor 340 to determine the coding, modulation, spreading, and/or scrambling schemes for the transmit processor 320. These channel estimates may be derived from a reference signal transmitted by the UE 350 or from feedback contained in the midamble 214 (FIG. 2) from the UE 350. The symbols generated by the transmit processor 320 are provided to a transmit frame processor 330 to create a frame structure. The transmit frame processor 330 creates this frame structure by multiplexing the symbols with a midamble 214 (FIG. 2) from the controller/processor 340, resulting in a series of frames. The frames are then provided to a transmitter 332, which provides various signal conditioning functions including amplifying, filtering, and modulating the frames onto a carrier for downlink transmission over the wireless medium through smart antennas 334. The smart antennas 334 may be implemented with beam steering bidirectional adaptive antenna arrays or other similar beam technologies.

At the UE 350, a receiver 354 receives the downlink transmission through an antenna 352 and processes the transmission to recover the information modulated onto the carrier. The information recovered by the receiver 354 is provided to a receive frame processor 360, which parses each frame, and provides the midamble 214 (FIG. 2) to a channel processor 394 and the data, control, and reference signals to a receive processor 370. The receive processor 370 then performs the inverse of the processing performed by the transmit processor 320 in the node B 310. More specifically, the receive processor 370 descrambles and despreads the symbols, and then determines the most likely signal constellation points transmitted by the node B 310 based on the modulation scheme. These soft decisions may be based on channel estimates computed by the channel processor 394. The soft decisions are then decoded and deinterleaved to recover the data, control, and reference signals. The CRC codes are then checked to determine whether the frames were successfully decoded. The data carried by the successfully decoded frames will then be provided to a data sink 372, which represents applications running in the UE 350 and/or various user interfaces (e.g., display). Control signals carried by successfully decoded frames will be provided to a controller/processor 390. When frames are unsuccessfully decoded by the receiver processor 370, the controller/processor 390 may also use an acknowledgement (ACK) and/or negative acknowledgement (NACK) protocol to support retransmission requests for those frames.

In the uplink, data from a data source 378 and control signals from the controller/processor 390 are provided to a transmit processor 380. The data source 378 may represent applications running in the UE 350 and various user interfaces (e.g., keyboard). Similar to the functionality described in connection with the downlink transmission by the node B 310, the transmit processor 380 provides various signal processing functions including CRC codes, coding and interleaving to facilitate FEC, mapping to signal constellations, spreading with OVSFs, and scrambling to produce a series of symbols. Channel estimates, derived by the channel processor 394 from a reference signal transmitted by the node B 310 or from feedback contained in the midamble transmitted by the node B 310, may be used to select the appropriate coding, modulation, spreading, and/or scrambling schemes. The symbols produced by the transmit processor 380 will be provided to a transmit frame processor 382 to create a frame structure. The transmit frame processor 382 creates this frame structure by multiplexing the symbols with a midamble 214 (FIG. 2) from the controller/processor 390, resulting in a series of frames. The frames are then provided to a transmitter 356, which provides various signal conditioning functions including amplification, filtering, and modulating the frames onto a carrier for uplink transmission over the wireless medium through the antenna 352.

The uplink transmission is processed at the node B 310 in a manner similar to that described in connection with the receiver function at the UE 350. A receiver 335 receives the uplink transmission through the antenna 334 and processes the transmission to recover the information modulated onto the carrier. The information recovered by the receiver 335 is provided to a receive frame processor 336, which parses each frame, and provides the midamble 214 (FIG. 2) to the channel processor 344 and the data, control, and reference signals to a receive processor 338. The receive processor 338 performs the inverse of the processing performed by the transmit processor 380 in the UE 350. The data and control signals carried by the successfully decoded frames may then be provided to a data sink 339 and the controller/processor, respectively. If some of the frames were unsuccessfully decoded by the receive processor, the controller/processor 340 may also use an acknowledgement (ACK) and/or negative acknowledgement (NACK) protocol to support retransmission requests for those frames.

The controller/processors 340 and 390 may be used to direct the operation at the node B 310 and the UE 350, respectively. For example, the controller/processors 340 and 390 may provide various functions including timing, peripheral interfaces, voltage regulation, power management, and other control functions. The computer readable media of memories 342 and 392 may store data and software for the node B 310 and the UE 350, respectively. For example, the memory 392 of the UE 350 may store an IRAT measurement module 391 which, when executed by the controller/processor 390, configures the UE 350 for determining an expected synchronization channel code word based on the operating frequency and base station identification code of a base station. A scheduler/processor 346 at the node B 310 may be used to allocate resources to the UEs and schedule downlink and/or uplink transmissions for the UEs.

### Scheduling IRAT Measurement During Continuous Transmission

A user equipment/mobile device (UE) may report channel quality by reporting a channel quality index (CQI) to a base station (node B). Such CQI reports indicate to the network the quality of the link between the base station and the user equipment. The CQI information may be used to configure a transport block size and/or modulation scheme for future transmissions in accordance with a particular communication protocol (e.g., HSDPA). The communication protocol may include physical channels such as, the high speed physical downlink shared channel (HS-PDSCH) and high speed shared information channel (HS-SICH). The HS-SICH carries the channel quality indicator (CQI), which includes the recommended transport block size (RTBS) and the recommended modulation format (RMF). The HS-SICH also carries a HARQ acknowledgement indicator (acknowledgement (ACK)/negative acknowledgement (NACK)) of the HS-PDSCH transmission.

During continuous transmission of the HS-PDSCH, however, a UE may be unable to schedule inter radio access technology (IRAT) measurements because the UE is allocated data every subframe such that all of the downlink time slots are occupied. Thus, IRAT measurements associated with GSM neighbor cells, for example, may not be performed during the continuous transmission. The unavailability of time slots for IRAT measurements may result in degraded communications. Thus, there is a desire to improve performance of a UE by providing time slots for IRAT measurements during periods of continuous data transmission.

Aspects of the present disclosure adjust the HS-PDSCH decoding/CQI reporting mechanism to allocate some downlink time slots to allow a UE to perform IRAT measurements. The adjustment of the HS-PDSCH decoding/CQI reporting mechanism may be based on a determination of whether IRAT measurements are overdue.

In some instances, the UE maintains a timer to determine when IRAT measurements are overdue or desired. For example, the timer may be configured to indicate a time before a desired IRAT measurement. Upon expiration of the timer, the UE may trigger a special mode of CQI reporting to facilitate allocation of time slots for the IRAT measurements. The special mode CQI reporting may cause the UE to perform IRAT measurements during a downlink timeslot during which the (UE) is allocated data. For example, IRAT measurement may be implemented on subframes specified for carrying scheduled downlink data.

In other instances, determining whether the IRAT measurements are desired is based at least in part on channel conditions. For example, an opportunistic scheduling scheme may be implemented where one or more communication parameters of the HS-PDSCH transmission are continuously monitored to determine whether the one or more communication parameters meet a predetermined threshold. The communication parameters may include received signal code power (RSCP), block error rate (BLER), signal to interference ratio (SIR) or other factors. For example, when the one or more communication parameters fall below the predetermined threshold the UE may trigger the special mode CQI reporting. Similarly, when a data rate of communication is low or below an acceptable threshold, the special mode CQI reporting is implemented instead of processing/decoding scheduled downlink data associated with the unacceptable threshold on a subframe.

The special mode CQI reporting may be implemented in different ways (e.g., four schemes). In one aspect of the present disclosure, the multiple schemes may be implemented according to a round robin approach during selection of HS-PDSCH hybrid automatic repeat request (HARQ) identification for IRAT measurements, to avoid an adverse impact of a particular HARQ process relative to other HARQ processes. The special mode CQI reporting may be implemented with limited or no impact on the long term performance (e.g., long term throughput) of the HS-PDSCH.

A first special mode CQI reporting scheme may be implemented such that HS-PDSCH demodulation/decoding is not scheduled for a specified subframe indicated by the UE even though the subframe carries scheduled downlink data. Instead, the UE uses the specified subframe for IRAT measurements. Because the scheduled downlink data in the specified subframe was not decoded, the UE reports a NACK on the HS-SICH for the specified subframe indicating that the scheduled downlink data was unsuccessfully received. The scheduled downlink data associated with the specified subframe may be retransmitted in a different subframe in response to the reception of the NACK. In this instance, the retransmitted subframe data may be decoded at the UE according to a normal CQI reporting scheme. Further, a CQI report may not be generated for the specified subframe because no HS-PDSCH tasks (e.g., decoding/demodulating) were performed on the specified subframe. As a result, a most recently generated CQI (i.e., the CQI reported for a previous subframe) on the HS-SICH is reported according to the first special mode CQI reporting scheme.

In some aspects of the disclosure, a second special mode CQI reporting scheme may also be implemented such that HS-PDSCH decoding is not scheduled for a specified subframe indicated by the UE even though the subframe carries data. Similar to the first scheme, the UE uses the specified subframe for IRAT measurements instead of decoding the scheduled downlink data in the specified subframe. In the second special mode CQI reporting scheme, however, the HS-SICH for indicating ACK/NACK for the specified subframe is not transmitted. Because no ACK/NACK for the specified subframe is transmitted, the base station may assume that the UE was unable to decode the control channel corresponding to the specified subframe. As a result, the base station may retransmit the control channel information and the scheduled downlink data. The retransmitted data may be decoded according to the normal mode CQI reporting scheme.

In a third special mode CQI reporting scheme, an HS-PDSCH transmission is continuously monitored to identify an HS-PDSCH transmission (e.g., a specified subframe) that has been verified (i.e., passed) according to a cyclic redundancy check (CRC). In one aspect of the disclosure, although the CRC is verified for the specified subframe, the UE may indicate, on HS-SICH, that the CRC is unverified (i.e., the CRC failed). In the meantime, decoding the allocated HS-PDSCH transmission or scheduled downlink data corresponding to the specified subframe is unnecessary because the allocated HS-PDSCH transmission or scheduled downlink data were already successfully decoded. In conjunction with the indication that the CRC is unverified, the UE reports a NACK on the HS-SICH after determining that the scheduled downlink data was successfully received. In some aspects of the disclosure, the NACK may be reported prior to the decoding of the HS-PDSCH transmission. Because of the NACK, the network retransmits the scheduled downlink data in a new subframe. When the network retransmits the scheduled downlink data in response to the NACK and/or the CRC indication, the scheduled downlink data in the retransmitted subframe is disregarded with respect to HS-PDSCH decoding. Instead, the retransmitted subframe is used for IRAT measurements and the UE sends an ACK on a corresponding HS-SICH even though the scheduled downlink data carried by the retransmitted subframe was not decoded. Similar to the first scheme, a most recently generated CQI (i.e., the CQI reported for a previous subframe) on the HS-SICH is reported. In some aspects of the disclosure, the recently generated CQI may be reported prior to the decoding of the HS-PDSCH transmission.

In one aspect of the present disclosure, an HS-PDSCH transmission (e.g., of a subframe) is identified to trigger fourth special mode CQI reporting scheme after it is determined that an IRAT measurement is overdue or otherwise desired. In this fourth scheme, the subframe may be identified for performing IRAT measurements. To facilitate performance of the IRAT measurements on the identified subframe, a recommended transport block size (RTBS) may be requested by the UE on a corresponding HS-SICH. The RTBS may be smaller than a RTBS normally calculated and recommended by the UE. For example, the UE may specify a smaller RTBS with fewer future downlink time slots relative to the current downlink time slots. Typically, the HS-SICH carries the CQI report, which includes the RTBS. When the reduced number of future downlink time slots is allocated, the remaining unoccupied downlink time slots may be used for IRAT measurements according to the fourth special mode CQI reporting scheme. For example, if the current number of RTBS downlink time slots is five and a smaller RTBS with one specified time slot in future RTBS downlink time slots is implemented, the remaining four unoccupied downlink RTBS time slots may be used for IRAT measurements when the node B allocates one time slot.

In one aspect of the disclosure, the request to reduce the number of RTBS downlink time slots may be repeatedly sent until the IRAT measurements are completed. The request may be sent repeatedly to accommodate when the network is unable to allocate the time slots to IRAT measurements, when the network is only able to allocate a fraction of the requested time slots or when the time slots are not enough to complete the IRAT measurements. For example, although a request for six downlink time slots specified for performing the IRAT measurements is submitted, the network may only free up three downlink time slots. As a result, the request is repeatedly sent until enough downlink time slots are allocated to complete the IRAT measurements.

The number of RTBS downlink time slots requested may be adjusted based on the space specified to complete ongoing IRAT measurements. For example, if an IRAT measurement specifies six RTBS downlink time slots and a first request receives an allocation of three RTBS downlink time slots, a second request may be submitted for the remaining three RTBS downlink time slots.

In this implementation, HS-PDSCH decoding as well as IRAT measurements can be performed on the same subframe. For example, the HS-PDSCH can be implemented in the reduced number of downlink time slots and the rest of the available downlink time slots can be used for IRAT measurements.

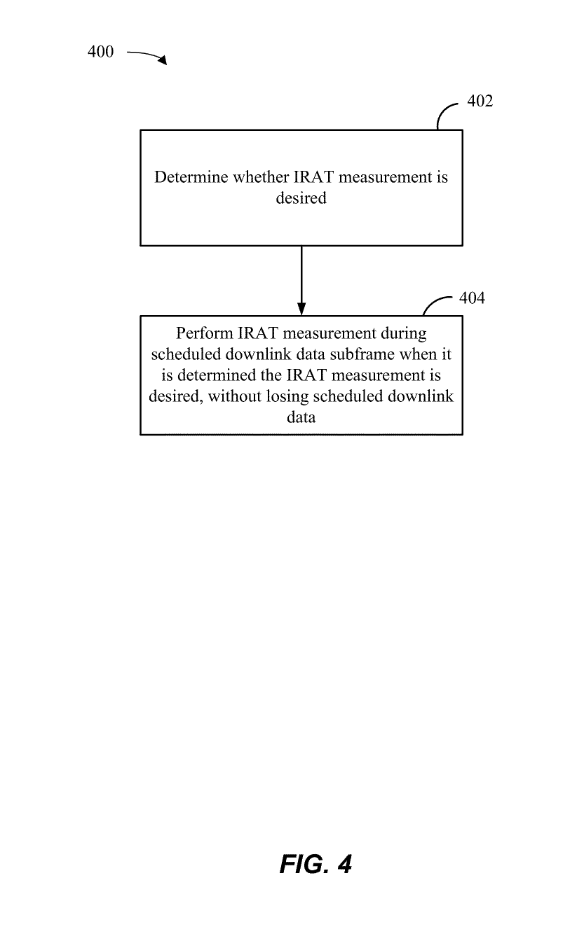

FIG. 4 shows a wireless communication method according to one aspect of the disclosure. A UE may determining whether an inter radio access technology (IRAT) measurement is desired, as shown in block 402. A UE may perform the IRAT measurement during a scheduled downlink data subframe when it is determined the IRAT measurement is desired, without losing the scheduled downlink data, as shown in block 404.

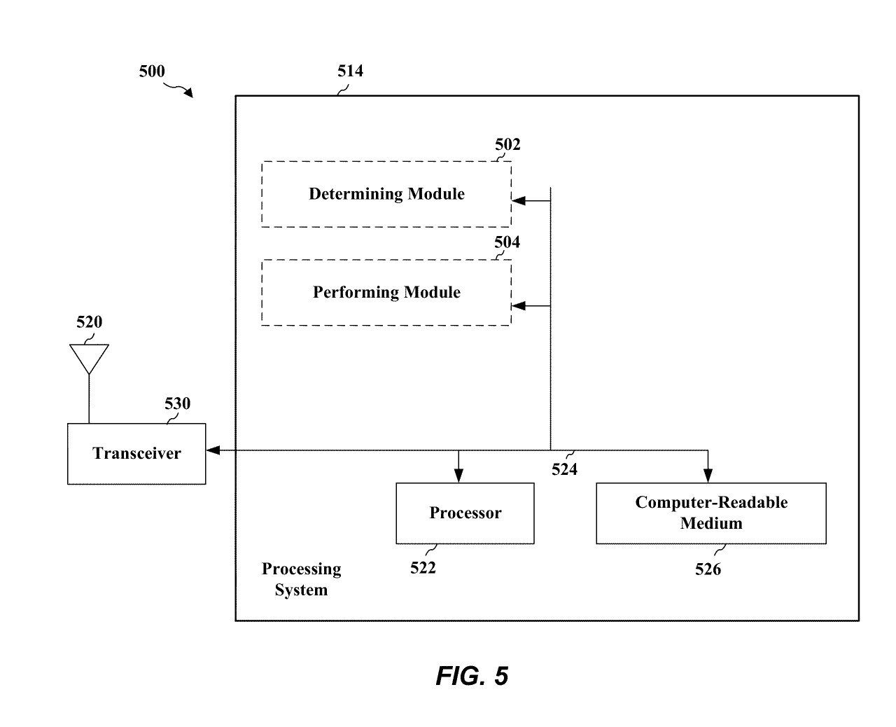

FIG. 5 is a diagram illustrating an example of a hardware implementation for an apparatus 500 employing a processing system 514. The processing system 514 may be implemented with a bus architecture, represented generally by the bus 524. The bus 524 may include any number of interconnecting buses and bridges depending on the specific application of the processing system 514 and the overall design constraints. The bus 524 links together various circuits including one or more processors and/or hardware modules, represented by the processor 522 the modules 502 and 504, and the computer-readable medium 526. The bus 524 may also link various other circuits such as timing sources, peripherals, voltage regulators, and power management circuits, which are well known in the art, and therefore, will not be described any further.

The apparatus includes a processing system 514 coupled to a transceiver 530. The transceiver 530 is coupled to one or more antennas 520. The transceiver 530 enables communicating with various other apparatus over a transmission medium. The processing system 514 includes a processor 522 coupled to a computer-readable medium 526. The processor 522 is responsible for general processing, including the execution of software stored on the computer-readable medium 526. The software, when executed by the processor 522, causes the processing system 514 to perform the various functions described for any particular apparatus. The computer-readable medium 526 may also be used for storing data that is manipulated by the processor 522 when executing software.

The processing system 514 includes a determining module 502 for determining whether an inter radio access technology (IRAT) measurement is desired. The processing system 514 includes a performing module 504 performing the IRAT measurement during a scheduled downlink data subframe when it is determined the IRAT measurement is desired, without losing the scheduled downlink data. The modules may be software modules running in the processor 522, resident/stored in the computer-readable medium 526, one or more hardware modules coupled to the processor 522, or some combination thereof. The processing system 514 may be a component of the UE 350 and may include the memory 392, and/or the controller/processor 390.

In one configuration, an apparatus such as a UE is configured for wireless communication including means for determining and means for performing. In one aspect, the above means may be the controller/processor 390, the memory 392, IRAT measurement module 391, determining module 502, performing module 504, and/or the processing system 514 configured to perform the functions recited by the aforementioned means. In another aspect, the aforementioned means may be a module or any apparatus configured to perform the functions recited by the aforementioned means.

Several aspects of a telecommunications system has been presented with reference to HSDPA systems. As those skilled in the art will readily appreciate, various aspects described throughout this disclosure may be extended to other telecommunication systems, network architectures and communication standards. By way of example, various aspects may be extended to other UMTS systems such as TD-SCDMA, W-CDMA, High Speed Uplink Packet Access (HSUPA), High Speed Packet Access Plus (HSPA+) and TD-CDMA. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Several processors have been described in connection with various apparatuses and methods. These processors may be implemented using electronic hardware, computer software, or any combination thereof. Whether such processors are implemented as hardware or software will depend upon the particular application and overall design constraints imposed on the system. By way of example, a processor, any portion of a processor, or any combination of processors presented in this disclosure may be implemented with a microprocessor, microcontroller, digital signal processor (DSP), a field-programmable gate array (FPGA), a programmable logic device (PLD), a state machine, gated logic, discrete hardware circuits, and other suitable processing components configured to perform the various functions described throughout this disclosure. The functionality of a processor, any portion of a processor, or any combination of processors presented in this disclosure may be implemented with software being executed by a microprocessor, microcontroller, DSP, or other suitable platform.

Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. A computer-readable medium may include, by way of example, memory such as a magnetic storage device (e.g., hard disk, floppy disk, magnetic strip), an optical disk (e.g., compact disc (CD), digital versatile disc (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, or a removable disk. Although memory is shown separate from the processors in the various aspects presented throughout this disclosure, the memory may be internal to the processors (e.g., cache or register).

Computer-readable media may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method of wireless communication, comprising:
determining whether an inter radio access technology (IRAT) measurement is desired; and
performing the IRAT measurement during a scheduled downlink data subframe when it is determined the IRAT measurement is desired, without losing scheduled downlink data.

2. The method of claim 1, further comprising:
decoding a retransmission of the scheduled downlink data.

3. The method of claim 2, further comprising:
transmitting a negative acknowledgment (NACK) in response to the scheduled downlink data subframe, prior to the decoding; and
transmitting a previous channel quality index (CQI) in response to the scheduled downlink data subframe, prior to the decoding.

4. The method of claim 1, further comprising:
decoding the scheduled downlink data in a previously scheduled subframe; and
transmitting a negative acknowledgment (NACK), after determining the scheduled downlink data was successfully received,
in which the performing the IRAT measurement occurs during a retransmission of the scheduled downlink data.

5. The method of claim 1, further comprising:
requesting a smaller recommended transport block size (RTBS);
in which the performing the IRAT measurement occurs during unoccupied time slots resulting from the requested smaller RTBS.

6. The method of claim 5, further comprising repeatedly requesting the smaller RTBS until enough time slots are available to complete the IRAT measurement.

7. The method of claim 1, in which determining whether the inter radio access technology (IRAT) measurement is desired is based at least in part on a timer.

8. The method of claim 1, in which determining whether the inter radio access technology (IRAT) measurement is desired is based at least in part on channel conditions.

9. The method of claim 1, in which the scheduled downlink data is scheduled on a High Speed-Physical Downlink Shared Channel (HS-PDSCH).

10. An apparatus for wireless communication, comprising:
means for determining whether an inter radio access technology (IRAT) measurement is desired; and
means for performing the IRAT measurement during a scheduled downlink data subframe when it is determined the IRAT measurement is desired, without losing scheduled downlink data.

11. An apparatus for wireless communication, comprising:
a memory; and
at least one processor coupled to the memory and configured:
to determine whether an inter radio access technology (IRAT) measurement is desired; and
to perform the IRAT measurement during a scheduled downlink data subframe when it is determined the IRAT measurement is desired, without losing scheduled downlink data.

12. The apparatus of claim 11, in which the at least one processor is further configured:
to decode a retransmission of the scheduled downlink data.

13. The apparatus of claim 12, in which the at least one processor is further configured:
to transmit a negative acknowledgment (NACK) in response to the scheduled downlink data subframe, prior to the decoding; and
to transmit a previous channel quality index (CQI) in response to the scheduled downlink data subframe, prior to the decoding.

14. The apparatus of claim 11, in which the at least one processor is further configured:
to decode the scheduled downlink data in a previously scheduled subframe; and
to transmit a negative acknowledgment (NACK), after determining the scheduled downlink data was successfully received,
in which the at least one processor is further configured to perform the IRAT measurement during a retransmission of the scheduled downlink data.

15. The apparatus of claim 11, in which the at least one processor is further configured:
to request a smaller recommended transport block size (RTBS), in which the at least one processor is further configured to perform the IRAT measurement during unoccupied time slots resulting from the requested smaller RTBS.

16. The apparatus of claim 15, in which the at least one processor is further configured to repeatedly request the smaller RTBS until enough time slots are available to complete the IRAT measurement.

17. The apparatus of claim 11, in which the at least one processor is further configured to determine whether the inter radio access technology (IRAT) measurement is desired based at least in part on a timer.

18. The apparatus of claim 11, in which the at least one processor is further configured to determine whether the inter radio access technology (IRAT) measurement is desired based at least in part on channel conditions.

19. The apparatus of claim 11, in which the scheduled downlink data is scheduled on a High Speed-Physical Downlink Shared Channel (HS-PDSCH).

20. A computer program product for wireless communications in a wireless network, comprising:
a non-transitory computer-readable medium having program code recorded thereon, the program code comprising:
program code to determine whether an inter radio access technology (IRAT) measurement is desired; and
program code to perform the IRAT measurement during a scheduled downlink data subframe when it is determined the IRAT measurement is desired, without losing scheduled downlink data.
